(19) United States
(12) Patent Application Publication
(10) Pub. No.: US 2006/0046154 A1
(43) Pub. Date: Mar. 2, 2006

(54) Low temperature Li/FeS2 battery

(75) Inventors: Andrew A. Webber, Avon Lake, OH (US); David A. Kaplin, Mayfield Heights, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 11/204,694

(22) Filed: Aug. 16, 2005

Related U.S. Application Data
(63) Continuation-in-part of application No. 10/943,169, filed on Sep. 16, 2004.
Application No. 10/943,169 is a continuation-in-part of application No. 10/928,943, filed on Aug. 27, 2004.

(51) Int. Cl. H01M 10/40

(52) U.S. Cl. 429/329; 429/336; 429/337

(57) ABSTRACT

The invention is an electrochemical battery cell, such as a Li/FeS₂ cell, with a nonaqueous liquid electrolyte having a solvent with a high ether content and a solute including LiI and one or more additional salts, preferably LiCF₃SO₃, that can avoid a sharp drop in voltage on high rate and high power discharge at low temperatures, while still providing reasonable capacity on high rate and high power discharge at room temperature. The electrolyte solvent includes 1,3-dioxolane and 1,2-dimethoxyethan in a volume ratio greater than 45:55 and less than 85:15. When the total solute concentration in the electrolyte is low (0.40 to 0.65 mol/l solvent), the solute contains at least 35 mole percent LiI, and when the total solute concentration in the electrolyte is high (greater than 0.65 to 2.0 mol/l solvent), the solute contains less than 35 mole percent LiI.

### CROSS-REFERENCE TO RELATED APPLICATIONS

This application is a continuation-in-part of U.S. patent application Ser. No. 10/943,169, filed Sep. 16, 2004, entitled Low Temperature Li/FeS₂ Battery, currently pending, which is a continuation-in-part of U.S. patent application Ser. No. 10/928,943, filed Aug. 27, 2004, entitled Low Temperature Li/FeS₂ Battery, currently pending.

### BACKGROUND

This invention relates to a primary nonaqueous electrolyte electrochemical battery cell, such as a lithium/iron disulfide cell, with good low temperature performance characteristics.

Batteries are used to provide power to many portable electronic devices. Common advantages of lithium batteries (those that contain metallic lithium or lithium alloy as the electrochemically active material of the negative electrode) include high energy density, good high rate and high power discharge performance, good performance over a broad temperature range, long shelf life and light weight. Lithium batteries are becoming increasingly popular as the battery of choice for new devices because of trends in those devices toward smaller size and higher power. The ability to use high power consumer devices in low temperature environments is also important. While lithium batteries can typically operate devices at lower temperatures than batteries with aqueous electrolytes, electrolyte systems that provide the best high power discharge characteristics, even after storage for long periods of time, do not always give the best performance at low temperatures.

One type of lithium battery, referred to below as a Li/FeS₂ battery, has iron disulfide as the electrochemically active material of the positive electrode. Li/FeS₂ batteries have used electrolyte systems with a wide variety of solutes and organic solvents. The salt/solvent combination is selected to provide sufficient electrolytic and electrical conductivity to meet the cell discharge requirements over the desired temperature range. While their polarity is relatively low compared to some other common solvents, ethers are often desirable because of their generally low viscosity, good wetting capability, good low temperature discharge performance and good high rate discharge performance. This is particularly true in Li/FeS₂ cells because the ethers are more stable than with higher voltage cathodes, so higher ether levels can be used. Among the ethers that have been used are 1,2-dimethoxyethane (DME) and 1,3-dioxolane (DIOX), which have been used together and in blends with other cosolvents. However, because of interactions among solvents, as well as with electrolyte solutes and electrodes, cell performance has been difficult to predict based on the properties of individual solvent and solute components.

A wide variety of solutes has been used in Li/FeS₂ cell electrolytes; lithium trifluoromethanesulfonate (also commonly referred to as lithium triflate or LiCF₃SO₃) is among them. An example of a Li/FeS₂ cell with a lithium triflate solute in a solvent blend comprising DIOX and DME is found in U.S. Pat. No. 4,952,330, which is hereby incorporated by reference. A solvent blend of 40 to 53 volume percent cyclic ether (e.g., DIOX), 32 to 40 volume percent linear aliphatic ether (e.g., DME) and 8 to 18 volume percent alkylene carbonate (e.g., propylene carbonate) is disclosed. However, such an electrolyte can result in poor cell discharge performance at high discharge rates.

Another example of a cell with an electrolyte containing lithium triflate dissolved in a solvent comprising DIOX and DME is found in U.S. Pat. No. 5,290,414, which is hereby incorporated by reference. A blend of from 1:99 to 45:55 DIOX:DME with an optional cosolvent (e.g., 0.2 weight percent 3,5-dimethylisoxazole (DMI)) is disclosed as a solvent. The disclosed cell had low impedance following storage at high temperature.

While electrolytes containing lithium triflate can provide fair cell electrical and discharge characteristics, such electrolytes have relatively low electrical conductivity, and lithium triflate has been relatively expensive. Lithium iodide (LiI) has been used as an alternative to lithium triflate to both reduce cost and improve cell electrical performance. U.S. Pat. No. 5,514,491, which is hereby incorporated by reference, discloses a cell with improved high rate discharge performance, even after storage at high temperature. LiI is the sole solute, and the electrolyte solvent comprises at least 97 volume percent ether (e.g., 20:80 to 30:70 by volume DIOX:DME, with 0.2 volume percent DMI as a cosolvent).

LiI has also been used in combination lithium triflate as the electrolyte solute. For example, U.S. Pat. No. 4,450,214, which is hereby incorporated by reference, discloses a Li/FeS₂ cell with an electrolyte that has a mixed solute of lithium triflate and a lithium halide, such as LiI. The solvent contains a blend of DIOX, DME, 3Me2Ox (3-methyl-2-oxazolidinone) and DMI in a ratio of 40/30/30/0.2 by volume. A cell with such an electrolyte reaches a stable OCV quickly and is resistant to the formation of a passivating film on the lithium, thereby improving the operating voltage on pulse discharge.

It has been discovered that when LiI is used as a solute in an electrolyte containing DME in the solvent, especially more than 40 volume percent, discharge capacity at low temperatures, such as −20° C. and below, can be very low. This is believed to be due to formation of a DME solvate that can precipitate from the electrolyte solution at low temperatures or otherwise degrade low temperature cell performance. Reducing the DME content in the solvent can prevent this problem, but some of the improvement in high rate and high power discharge performance realized with LiI as the solute is sacrificed. Copending U.S. patent application Ser. Nos. 10/928,943, filed Aug. 27, 2004, and Ser. No. 10/943,169, filed Sep. 16, 2004, which are hereby incorporated by reference, disclose cells in which this problem is solved by using an electrolyte solvent that either includes 1,2-dimethoxypropane (DMP) and less than 30 volume percent DME or includes 45 to 80 volume percent DME and 5 to 25 volume percent 3Me2Ox.

More recently it has been discovered that Li/FeS₂ cells with electrolytes that have a solvent with a high ether content and LiI as a solute (either the sole solute or in combination with lithium triflate) can, on high rate discharge at low temperatures, exhibit a rapid drop in voltage near the beginning of discharge. The voltage can drop so low that a device being powered by the cell will not operate. Eliminating LiI as a solute (e.g., by using lithium triflate as the sole solute) can solve this problem, but the operating voltage can then be too low on high rate and high power discharge at room temperature.

In view of the above, an object of the present invention is to provide an economical nonaqueous electrolyte battery cell, particularly a primary Li/FeS₂ cell that does not exhibit a sharp voltage drop near the beginning of high rate and high power discharge at low temperature, while still providing reasonably good capacity on high rate and high power discharge at room temperature.

### SUMMARY

The above objects are met and the above disadvantages of the prior art are overcome by using an electrolyte having a solute comprising lithium iodide and one or more additional soluble salts.

Accordingly, one aspect of the present invention is directed to an electrochemical battery cell having a negative electrode comprising an alkali metal, a positive electrode, a separator disposed between the negative and positive electrodes, and an electrolyte. The electrolyte has a solvent containing at least 80 volume percent ethers, and the ethers include a 1,3-dioxolane based ether and a 1,2-dimethoxyethane based ether in a volume ratio greater than 45:55 and less than 85:15. The electrolyte also has a solute containing lithium iodide and one or more additional salts dissolved in the solvent, and the total solute concentration is from 0.40 to 2.00 moles per liter of solvent. When the electrolyte contains from 0.40 to 0.65 moles of solute per liter of solvent, the solute contains at least 35 mole percent lithium iodide, and when the electrolyte comprises from greater than 0.65 to 2.00 moles of solute per liter of solvent, the solute contains less than 35 mole percent lithium iodide. Preferably the additional salt(s) comprise lithium trifluoromethane sulfonate.

A second aspect of the present invention is directed to a primary electrochemical battery cell having a negative electrode containing metallic lithium, a positive electrode containing FeS₂, a separator disposed between the negative and positive electrodes, and a liquid electrolyte. The electrolyte has a solvent containing at least 80 volume percent ethers, and the ethers include 1,3-dioxolane and 1,2-dimethoxyethane in a volume ratio greater than 45:55 and less than 85:15. The electrolyte also has a solute containing lithium iodide and lithium trifluoromethane sulfonate, the total solute concentration is from 0.40 to 0.65 moles per liter of solvent and the solute contains at least 35 mole percent lithium iodide.

A third aspect of the present invention is directed to a primary electrochemical battery cell having a negative electrode containing metallic lithium, a positive electrode containing FeS₂, a separator disposed between the negative and positive electrodes, and a liquid electrolyte. The electrolyte has a solvent containing at least 80 volume percent ethers, and the ethers include 1,3-dioxolane and 1,2-dimethoxyethane in a volume ratio greater than 45:55 and less than 85:15. The electrolyte also has a solute containing lithium iodide and lithium trifluoromethane sulfonate, the total solute concentration is from greater than 0.65 to 2.00 moles per liter of solvent and the solute contains less than 35 mole percent lithium iodide.

These and other features, advantages and objects of the present invention will be further understood and appreciated by those skilled in the art by reference to the following specification, claims and appended drawings.

Unless otherwise specified herein, all disclosed characteristics and ranges are as determined at room temperature (20-25° C.).

As used herein:
1. about means including normal variability due to sampling and measurement;
2. primary solute means the solute component that makes up more than 50 mole percent of the total amount of solute in an electrolyte; and
3. volumes of solvent components refer to the volumes of cosolvents that are mixed together to make the solvent for an electrolyte; volume ratios of cosolvents can be determined from the weight ratios of the cosolvents by dividing the relative weights of each of the cosolvents by their respective densities at 20° C. (e.g., 0.867 g/cm³ for DME, 1.176 g/cm³ for 3Me2Ox, 1.065 g/cm³ for DIOX and 0.984 g/cm³ for DMI).

### BRIEF DESCRIPTION OF THE DRAWINGS

In the drawings:

FIG. 1 is an embodiment of a cylindrical cell with a lithium negative electrode, an iron disulfide positive electrode and a nonaqueous organic electrolyte;

FIG. 2 is a plot of capacity on the x-axis and voltage on the y-axis for nonaqueous electrolyte cells with different LiI concentrations in the electrolyte when discharged at a constant current of 1000 mA at −20° C.; and

FIG. 3 is a plot of capacity on the x-axis and voltage on the y-axis for nonaqueous electrolyte cells with different LiI concentrations in the electrolyte when discharged at a constant current of 1000 mA at −40° C.

### DESCRIPTION

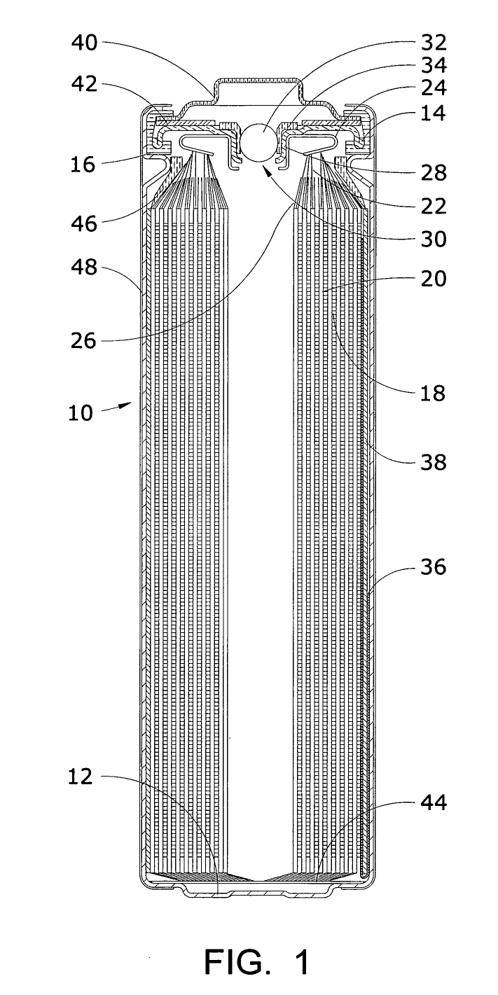

The invention will be better understood with reference to FIG. 1, which shows an FR6 type cylindrical battery cell having a housing sealed by two thermoplastic seal members (a gasket and a vent bushing). Cell 10 has a housing that includes a can 12 with a closed bottom and an open top end that is closed with a cell cover 14 and a gasket 16. The can 12 has a bead or reduced diameter step near the top end to support the gasket 16 and cover 14. The gasket 16 is compressed between the can 12 and the cover 14 to seal a negative electrode (anode) 18, a positive electrode (cathode) 20 and electrolyte within the cell 10. The anode 18, cathode 20 and a separator 26 are spirally wound together into an electrode assembly. The cathode 20 has a metal current collector 22, which extends from the top end of the electrode assembly and is connected to the inner surface of the cover 14 with a contact spring 24. The anode 18 is electrically connected to the inner surface of the can 12 by a metal tab (not shown). An insulating cone 46 is located around the peripheral portion of the top of the electrode assembly to prevent the cathode current collector 22 from making contact with the can 12, and contact between the bottom edge of the cathode 20 and the bottom of the can 12 is prevented by the inward-folded extension of the separator 26 and an electrically insulating bottom disc 44 positioned in the bottom of the can 12. Cell 10 has a separate positive terminal cover 40, which is held in place by the inwardly crimped top edge of the can 12 and the gasket 16. The can 12 serves as the negative contact terminal. Disposed between the peripheral flange of the terminal cover 40 and the cell cover 14 is a positive temperature coefficient (PTC) device 42 that substantially limits the flow of current under abusive electrical conditions. Cell 10 also includes a pressure relief vent. The cell cover 14 has an aperture comprising an inward projecting central vent well 28 with a vent hole 30 in the bottom of the well 28. The aperture is sealed by a vent ball 32 and a thin-walled thermoplastic bushing 34, which is compressed between the vertical wall of the vent well 28 and the periphery of the vent ball 32. When the cell internal pressure exceeds a predetermined level, the vent ball 32, or both the ball 32 and bushing 34 are forced out of the aperture to release pressurized fluids from the cell 10.

Electrolytes for cells according to the invention are nonaqueous electrolytes. In other words, they contain water only in very small quantities (preferably no more than about 500 parts per million by weight) as a contaminant. The electrolyte comprises a solute dissolved in an organic solvent containing at least 80 volume percent ethers, including at least DIOX (e.g., 1,3-dioxolane and 1,3-dioxolane based ethers), and DME (e.g., 1,2-dimethoxyethane and 1,2-dimethoxyethane based ethers), with the DIOX and DME in a volume ratio greater than about 45:55 and less than about 85:15. Preferably the DIOX:DME volume ratio is no greater than about 75:25, more preferably no greater than about 70:30 and most preferably no greater than about 65:35. Preferably the DIOX:DME ratio is at least 50:50. When the ether content is too low, high rate discharge performance suffers, especially at low temperatures. When the DIOX:DME ratio is too low or too high, low temperature discharge capacity can be poor, and when the ratio is too high, discharge capacity in a digital still camera at room temperature can be poor. Preferably the total amount of DIOX and DME in the solvent is at least 80 volume percent, more preferably at least 90 volume percent. Examples of DIOX based ethers include alkyl- and alkoxy-substituted DIOX, such as 2-methyl-1,3-dioxolane and 4-methyl-1,3-dioxolane. Examples of DME based ethers include diglyme, triglyme, tetraglyme and ethyl glyme.

The solvent can also include additional cosolvents, examples of which include ethylene carbonate, propylene carbonate, 1,2-butylene carbonate, 2,3-butylene carbonate, vinylene carbonate, methyl formate, γ-butyrolactone, sulfolane, acetonitrile, 3,5-dimethylisoxazole, N,N-dimethyl formamide, N,N-dimethylacetamide, N,N-dimethylpropyleneurea, 1,1,3,3-tetramethylurea, beta aminoenones, beta aminoketones, and other ethers such as methyltetrahydrofurfuryl ether, diethyl ether, tetrahydrofuran, 2-methyl tetrahydrofuran, 2-methoxytetrahydrofuran, 2,5-dimethoxytetrahydrofuran, and 1,2-dimethoxypropane based compounds (1,2-dimethoxypropane and substituted 1,2-dimethoxypropane). DMI, DMP and 3Me2Ox are preferred cosolvents, particularly DMI. Because they can react with LiI, the solvent preferably contains a total of less than 5 volume percent, and more preferably, no dialkyl or cyclic carbonates.

The solute includes LiI and one or more additional salts dissolved in the solvent. The total amount of solute in the electrolyte is between about 0.40 and about 2.00 moles per liter of solvent. Preferably the total solute concentration is at least 0.50 moles per liter of solvent. Preferably the total solute concentration is no greater than about 1.50 moles per liter of solvent, more preferably no greater than about 1.20 moles per liter of solvent. When the solute concentration is too high, the electrolyte solvent viscosity can be too high, leading to low operating voltages at low temperatures. When the concentration is too low, there are not enough lithium ions present to support high currents, and voltage is poor on high rate discharge at and below room temperature.

When the electrolyte contains from about 0.40 to about 0.65 moles of solute per liter of solvent, the solute contains at least about 35, preferably at least about 40, mole percent LiI. Within the range of 0.40 to 0.65 moles of solute per liter of solvent, the total solute concentration is more preferably from about 0.50 to 0.60 moles per liter of solvent. In a preferred embodiment with 0.40 to 0.65 moles of solute per liter of solvent, the mole ratio of LiI to the additional salt(s) is from about 60:40 to about 99:1, more preferably from about 60:40 to about 90:10, and most preferably from about 65:35 to about 75:25.

When the electrolyte contains from greater than about 0.65 to about 2.00 moles of solute per liter of solvent, the solute contains less than 35, preferably no more than about 30, mole percent LiI. Within the range of 0.65 to 2.00 moles of solute per liter of solvent, the total solute concentration is from about 0.70 to 1.20 moles per liter of solvent. In a preferred embodiment with 0.65 to 2.0 moles of solute per liter of solvent, the mole ratio of LiI to the additional salt(s) is from about 10:90 to about 30:70 and more preferably from about 10:90 to about 20:80. Preferably the LiI concentration is at least about 0.10 moles per liter of solvent. Preferably the LiI concentration is no greater than 0.20, moles per liter of solvent.

The additional soluble salt(s) can include one or a combination of salts that are stable in ether solvents. Lithium salts are preferred. Examples include LiCF₃SO₃, LiClO₄, Li(CF₃SO₂)₂N, Li(CF₃CF₂SO₂)₂N, Li(CF₃SO₂)₃C and lithium bis(oxalato)borate. LiCF₃SO₃ is a preferred lithium salt.

The anode contains an alkali metal, such as lithium, sodium or potassium metal, often in the form of a sheet or foil. The composition of the alkali metal can vary, though the purity is always high. The alkali metal can be alloyed with other metals, such as aluminum, to provide the desired cell electrical performance. A preferred alkali metal is a lithium metal, more preferably lithium metal alloyed with aluminum, most preferably with about 0.5 weight percent aluminum. When the anode is a solid piece of lithium, a separate current collector within the anode is not required, since the lithium metal has a very high electrical conductivity. However, a separate current collector can be used.

The cathode contains one or more active materials. Preferably the active materials, when coupled with the anode in the cell, result in a nominal cell open circuit voltage of 1.5 volts. Preferred active cathode materials include iron sulfides (e.g., FeS and FeS₂), more preferably iron disulfide (FeS₂), usually in particulate form. Examples of other active materials include oxides of bismuth, such as Bi₂O₃, as well as CuO, Cu₂O, CuS and Cu₂S. In addition to the active material, the cathode generally contains one or more electrically conductive materials such as metal or carbon (e.g., graphite, carbon black and acetylene black). A binder may be used to hold the particulate materials together, especially for cells larger than button size. Small amounts of various additives may also be included to enhance processing and cell performance. The particulate cathode materials can be formed into the desired electrode shape and inserted into the cell, or they can be applied to a current collector. For example, a coating can be applied to a thin metal foil strip for use in a spirally wound electrode assembly, as shown in FIG. 1. Aluminum is a commonly used material for the cathode current collector.

Any suitable separator material may be used. Suitable separator materials are ion-permeable and electrically nonconductive. They are generally capable of holding at least some electrolyte within the pores of the separator. Suitable separator materials are also strong enough to withstand cell manufacturing and pressure that may be exerted on them during cell discharge without tears, splits, holes or other gaps developing. Examples of suitable separators include microporous membranes made from materials such as polypropylene, polyethylene and ultrahigh molecular weight polyethylene. Preferred separator materials for Li/FeS₂ cells include CELGARD® 2400 and 2500 microporous polypropylene membranes (from Celgard Inc., Charlotte, N.C., USA) and Tonen Chemical Corp.'s Setella F20DHI microporous polyethylene membrane (available from ExxonMobile Chemical Co, Macedonia, N.Y., USA). A layer of a solid electrolyte, a polymer electrolyte or a gel-polymer electrolyte can also be used as a separator.

Specific anode, cathode and electrolyte compositions and amounts can be adjusted and the separator selected to provide the desired cell manufacturing, performance and storage characteristics. U.S. Pat. No. 6,849,360, which is hereby incorporated by reference, discloses a Li/FeS₂ cell with high energy density and discharge efficiency. Electrolyte according to the present invention can be used advantageously in such a cell.

The cell container is often a metal can with an integral closed bottom, though a metal tube that is initially open at both ends may also be used instead of a can. The can is generally steel, plated with nickel on at least the outside to protect the outside of the can from corrosion. The type of plating can be varied to provide varying degrees of corrosion resistance or to provide the desired appearance. The type of steel will depend in part on the manner in which the container is formed. For drawn cans the steel can be a diffusion annealed, low carbon, aluminum killed, SAE 1006 or equivalent steel, with a grain size of ASTM 9 to 11 and equiaxed to slightly elongated grain shape. Other steels, such as stainless steels, can be used to meet special needs. For example, when the can is in electrical contact with the cathode, a stainless steel may be used for improved resistance to corrosion by the cathode and electrolyte.

The cell cover is typically metal. Nickel plated steel may be used, but a stainless steel is often desirable, especially when the cover is in electrical contact with the cathode. The complexity of the cover shape will also be a factor in material selection. The cell cover may have a simple shape, such as a thick, flat disk, or it may have a more complex shape, such as the cover shown in FIG. 1. When the cover has a complex shape like that in FIG. 1, a type 304 soft annealed stainless steel with ASTM 8-9 grain size may be used, to provide the desired corrosion resistance and ease of metal forming. Formed covers may also be plated, with nickel for example.

The terminal cover should have good resistance to corrosion by water in the ambient environment, good electrical conductivity and, when visible on consumer batteries, an attractive appearance. Terminal covers are often made from nickel plated cold rolled steel or steel that is nickel plated after the covers are formed. Where terminals are located over pressure relief vents, the terminal covers generally have one or more holes to facilitate cell venting.

The gasket comprises a thermoplastic material that is resistant to cold flow at high temperatures (e.g., 75° C. and above), chemically stable (resistant to degradation, e.g., by dissolving or cracking) when exposed to the internal environment of the cell and resistant to the transmission of air gases into and electrolyte vapors from the cell. Gaskets can be made from thermoplastic resins. For a cell with an electrolyte having a high ether content, preferred resins comprise polypropylene, polyphthalamide and polyphenylene sulfide. Examples include PRO-FAX® 6524 grade polypropylene from Basell Polyolefins, Wilmington, Del., USA; RTP 4000 grade polyphthalamide from RTP Company, Winona, Minn., USA; AMODEL® ET 1001 L (polyphthalamide with 5-40 weight percent impact modifier) from Solvay Advanced Polymers, LLC, Alpharetta, Ga., USA; and FORTRON® SKX 382 (polyphenylene sulfide with about 15 weight percent impact modifier) from Ticona-US, Summit, N.J., USA.

To improve the seal at the interfaces between the gasket and the cell container and the cell cover, the gasket can be coated with a suitable sealant material. A polymeric material such as ethylene propylene diene terpolymer (EPDM) can be used.

The vent bushing is a thermoplastic material that is resistant to cold flow at high temperatures (e.g., 75° C. and above). The resin can be formulated to provide the desired sealing, venting and processing characteristics. For example, the base resin can be modified by adding a thermal-stabilizing filler to provide a vent bushing with the desired sealing and venting characteristics at high temperatures. Suitable polymeric base resins include ethylene-tetrafluoroethylene, polyphenylene sulfide, polyphthalamide, ethylene-chlorotrifluoroethylene, chlorotrifluoroethylene, perfluoroalkoxyalkane, fluorinated perfluoroethylene polypropylene and polyetherether ketone. Ethylene-tetrafluoroethylene copolymer (ETFE), polyphenylene sulfide (PPS) and polyphthalamide (PPA) are preferred. Fillers may be inorganic materials, such as glass, clay, feldspar, graphite, mica, silica, talc and vermiculite, or they may be organic materials such as carbons. An example of a suitable thermoplastic resin is TEFZEL® HT2004 (ETFE resin with 25 weight percent chopped glass filler) from E.I. du Pont de Nemours and Company, Wilmington, Del., USA.

It is generally preferred that the wall of the vent bushing between the vent ball and the vent well in the cover be thin (e.g., 0.006 to 0.015 inch as manufactured) and be compressed by about 25 to 40 percent when the bushing and ball are inserted into the cover.

The vent ball can be made from any suitable material that is stable in contact with the cell contents and provides the desired cell sealing and venting characteristic. Glasses or metals, such as stainless steel, can be used. The vent ball should be highly spherical and have a smooth surface finish with no imperfections, such as gouges, scratches or holes visible under 10 times magnification. The desired sphericity and surface finish depend in part on the ball diameter. For example, in one embodiment of a Li/FeS₂ cell, for balls about 0.090 inch (2.286 mm) in diameter the preferred maximum sphericity is 0.0001 inch (0.00254 mm) and the preferred surface finish is 3 microinches (0.0762 μm) RMS maximum. For balls about 0.063 inch (1.600 mm) in diameter, the preferred maximum sphericity is 0.000025 inch (0.000635 mm), and the preferred maximum surface finish is 2 microinches (0.0508 μm) RMS.

The cell can be closed and sealed using any suitable process. Such processes may include, but are not limited to, crimping, redrawing, colleting, gluing and combinations thereof. For example, for the cell in FIG. 1, a bead is formed in the can after the electrodes and insulator cone are inserted, and the gasket and cover assembly (including the cell cover, contact spring and vent bushing) are placed in the open end of the can. The cell is supported at the bead while the gasket and cover assembly are pushed downward against the bead. The diameter of the top of the can above the bead is reduced with a segmented collet to hold the gasket and cover assembly in place in the cell. After electrolyte is dispensed into the cell through the apertures in the vent bushing and cover, a vent ball is inserted into the bushing to seal the aperture in the cell cover. A PTC device and a terminal cover are placed onto the cell over the cell cover, and the top edge of the can is bent inward with a crimping die to retain the gasket, cover assembly, PTC device and terminal cover and complete the sealing of the open end of the can by the gasket.

Following assembly the cell can be predischarged, such as by discharging the cell by a small amount (e.g., removing a total of about 180 maH of the cell capacity of an FR6 type cell) in one or more pulses.

The above description is particularly relevant to FR6 type cylindrical Li/FeS₂ cells with nonaqueous electrolytes and to pressure relief vents comprising a thermoplastic bushing and vent ball. However, the invention may also be adapted to other sizes and types of cells, such as button cells, pouch cells, non-cylindrical (e.g., prismatic) cells and cells with other pressure relief vent designs. Cells according to the invention can have spiral wound electrode assemblies, such as that shown in FIG. 1, or another electrode configuration, such as folded strips, stacked flat plates, bobbins and the like.

The present invention is useful for avoiding sharp voltage drops near the beginning of high rate and high power discharge at low temperatures. This phenomenon is different from a normal lowering of the cell discharge curve (e.g., voltage as a function of time on discharge) at low temperatures compared to room temperature, and electrolytes that improve one of these two conditions can actually worsen the other. The problem of sharp voltage drops in cells with electrolytes including LiI in a DIOX/DME solvent when discharged at high rates and very low temperatures as well as the features and advantages of the invention are illustrated in the following examples.

### EXAMPLE 1

FR6 type Li/FeS₂ cells similar to cell 10 in FIG. 1 were made to evaluate low temperature discharge performance on discharge at various constant current rates. The anode material was lithium metal alloyed with 0.5 weight percent aluminum (about 0.97 grams/cell average). The cathode was a strip of aluminum foil coated on both sides with cathode mixture (about 5.0 grams/cell) containing about 92 weight percent FeS₂, 1.4 weight percent acetylene black, 4 weight percent graphite, 2 weight percent binder, 0.3 weight percent micronized PTFE and 0.3 weight percent fumed silica. A 25 μm thick polypropylene separator was used. The average amount of electrolyte was about 1.6 grams per cell. The electrolyte contained a solvent blend of DIOX, DME and DMI in a ratio of 65:35:0.2 by volume LiI as the solute. Three lots of cells were made, each with a different concentration of LiI in the electrolyte (Lots 1, 2 and 3 with 0.3, 0.5 and 0.75 moles of LiI per liter of solvent, respectively). The cells were predischarged following assembly.

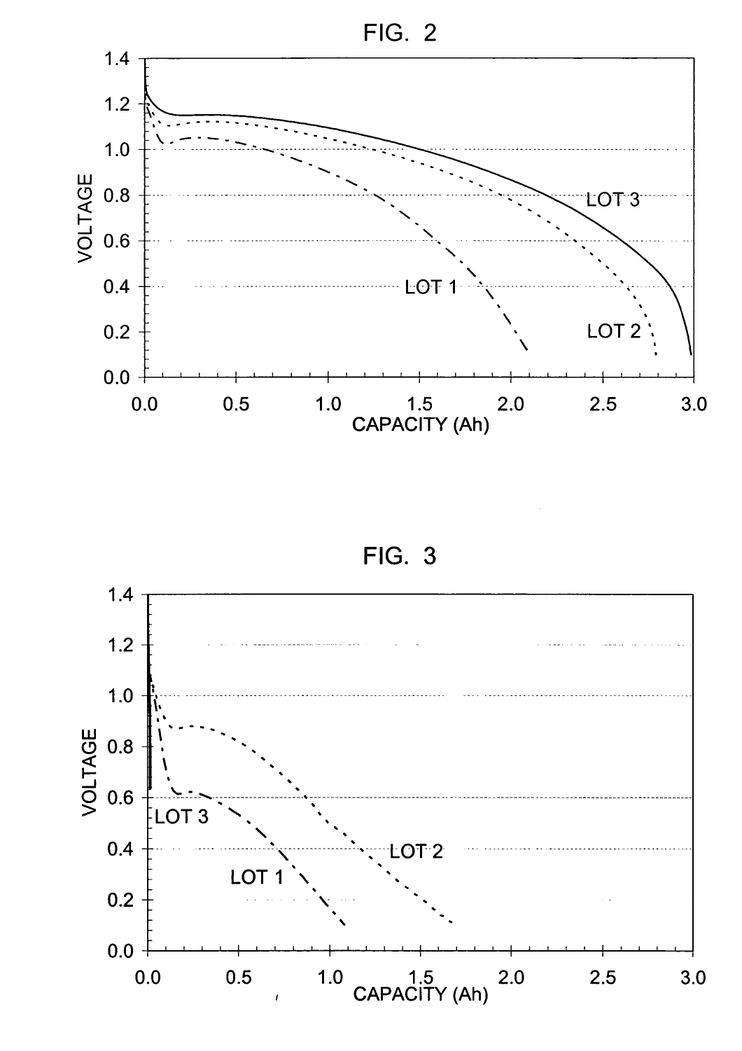

Cells from each of the lots were discharged continuously at a rate of 1000 mA at each of two temperatures: −20° C. and −40° C. Discharge curves, showing the capacity in Ah on the x-axis and cell voltage on the y-axis for representative cells from each lot, are shown in FIGS. 2 and 3. At −20° C. (FIG. 2) the cell capacity increases with increasing LiI concentration. The same is true at −40° C. (FIG. 3) for the lower LiI concentrations (0.3 and 0.5 moles per liter of solvent), but with 0.75 moles of LiI per liter of solvent, the cell voltage drops rapidly to less than 0.65 V, typically within the first several minutes on discharge, giving almost no useable capacity. In general, at low temperatures the lower the temperature the lower the operating voltage of the cell, resulting in reduced cell capacity, particularly to higher voltages. The sharp drop in voltage observed in Lot 3 is a different phenomenon.

Cells from Lot 3 were also discharged on a variety of different constant current rates ranging from 500 to 2000 mA and over a range of temperatures from −20 to −40° C. On the higher discharge rates and at the lower temperatures, the cell voltages dropped sharply, in some cases to a voltage well below a desired minimum (e.g., the minimum required to operate a device). While cell voltages were sometimes observed to recover as discharge continued, once a cell drops the minimum voltage required to operate a device, it would normally be considered fully discharged by a user, and the device turned off or the cell replaced before the cell voltage would recover to above the required minimum voltage. The occurrences of the sharp voltage drops observed and the corresponding minimum voltages are summarized in Table 1, in which an asterisk (*) indicates that no sharp voltage drop was observed, a voltage value indicates the minimum voltage observed, and “−” indicates no cells were tested. In general, sharp voltage drops were not observed at discharge rates of 1000 mA and below at −20° C., but at higher discharge rates sudden drops were observed, and the higher the discharge rate the lower the voltage dropped. At temperatures below −20° C., the lower the temperature, the lower the rate below which no sudden voltage drop is observed and the lower the sudden voltage drop for any given discharge rate.

TABLE 1

| Discharge | | | | | |
|---|---|---|---|---|---|
| Rate | Temperature | | | | |
| (mA) | −20° C. | −25° C. | −30 C. | −35° C. | −40° C. |
| 500 | * | * | * | 1.27 | 111 |
| 600 | * | * | * | 1.19 | 1.02 |
| 700 | * | * | * | 1.03 | 0.61 |
| 800 | * | * | 1.13 | 0.91 | 0.25 |
| 900 | * | * | 0.99 | 0.85 | 0.09 |
| 1000 | * | 1.15 | 0.97 | 0.62 | 0.09 |
| 1300 | 1.09 | — | — | — | — |
| 1500 | 0.98 | — | — | — | — |
| 2000 | 0.84 | — | — | — | — |

### EXAMPLE 2

FR6 cells were made using the same anode and cathode materials as in Example 1. However, the separator was 20 μm thick polyethylene (rather than 25 μm thick polypropylene), allowing increases in the amounts of lithium and cathode material to 0.99 and 5.17 grams, respectively. Eighteen lots of cells (Lots 4-21) were made using different electrolytes. As shown in Table 2, all electrolyte compositions had solvents consisting of DIOX and DME in varying ratios, as well as 0.2 volume percent DMI; and salts consisting of LiI and/or LiCF₃SO₃ (LiTFS) in varying ratios and varying total concentrations. Cells from each lot were discharged on 4 tests: (1) a digital still camera test (1.5 W×2 seconds, then 0.65 W×28 seconds, repeated 10 times per hour, 24 hours per day at room temperature to 1.1 volts), (2) a 1000 mA intermittent test (1000 mA 2 minutes on, then 5 minutes off, repeated continuously at −20° C. to 1.0 volt), (3) a 1250 mA intermittent test (1250 mA 6 minutes on, then 5 minutes off, repeated continuously at −30° C. to 0.773 volt), and 4) a 1250 mA continuous test (1250 mA continuous at −30° C. to 0.773 volt).

The results are summarized in Table 2; discharge capacities are indexed to Lot 21 (100×capacity/Lot 21 capacity); the relative capacity of Lot 21 is 100 on each test. An asterisk (*) indicates those lots in which sudden voltage drops to below the end voltage occurred. The results show that with a high DIOX:DME ratio of 85:15, capacity on the DSC test at room temperature was less than Lot 21, particularly when a mixed LiI/LiTFS salt is used. Capacity on the DSC test at room temperature was better than Lot 21 when a low DIOX:DME ratio of 45:55 was used, but low temperature performance was poor.

TABLE 2

| | | | Total | | DSC to | 1000 mA | 1250 mA | 1250 mA |
|---|---|---|---|---|---|---|---|---|
| | DIOX/ | LiI/ | Salt | LiI | 1.1 V | inter. to | inter. to | cont. to |
| Lot | DME | LiTFS | (mol/l | (mol/l | (room | 1.0 V | 0.773 V | 0.773 V |
| No. | (vol.) | (mol.) | solvent) | solvent) | temp.) | (−20° C.) | (−30° C.) | (−30° C.) |
| 4 | 45/55 | 70/30 | 0.75 | 0.525 | 101 | 78 | 19 | * |
| 5 | 85/15 | 70/30 | 0.75 | 0.525 | 73 | 66 | <1 | * |
| 6 | 45/55 | 100/0 | 0.75 | 0.750 | 108 | 31 | 6 | * |
| 7 | 85/15 | 100/0 | 0.75 | 0.750 | 84 | 1 | <1 | * |
| 8 | 45/55 | 70/30 | 1 | 0.700 | 106 | 40 | 9 | * |
| 9 | 85/15 | 70/30 | 1 | 0.700 | 89 | 2 | <1 | * |
| 10 | 45/55 | 100/0 | 1 | 1.000 | 110 | 12 | 3 | * |
| 11 | 85/15 | 100/0 | 1 | 1.000 | 97 | <1 | <1 | * |
| 12 | 45/55 | 85/15 | 0.875 | 0.744 | 107 | 31 | 7 | * |
| 13 | 85/15 | 85/15 | 0.875 | 0.744 | 90 | 2 | <1 | * |
| 14 | 65/35 | 70/30 | 0.875 | 0.613 | 102 | 98 | 105 | 99 |
| 15 | 65/35 | 100/0 | 0.875 | 0.875 | 106 | 103 | <1 | 22 |
| 16 | 65/35 | 85/15 | 0.75 | 0.638 | 100 | 97 | 112 | 102 |
| 17 | 65/35 | 85/15 | 1 | 0.850 | 107 | 100 | <1 | <1 |
| 18 | 65/35 | 85/15 | 0.875 | 0.744 | 105 | 98 | 106 | 50 |
| 19 | 65/35 | 85/15 | 0.875 | 0.744 | 104 | 103 | 2 | 64 |
| 20 | 65/35 | 100/0 | 0.75 | 0.750 | 101 | 95 | 61 | 98 |
| 21 | 65/35 | 100/0 | 0.75 | 0.750 | 100 | 100 | 100 | 100 |

### EXAMPLE 3

FR6 cells similar to those in Example 2 were made using various electrolytes. All electrolytes had solvents consisting of DIOX and DME, in varying ratios, as well as DMI; the ratio of the combination of DIOX and DME to DMI was 99.8:0.2 by volume. All electrolytes had solutes consisting of LiI in varying concentrations, ranging from 0.5 to 1.5 moles per liter of solvent, as shown in Table 3.

Cells from each lot were discharged on each of three tests: (1) a DSC test similar to that described in Example 2, except the end voltage was 1.05 rather than 1.1 V, (2) a 1000 mA continuous test to 1.0 V at room temperature, and (3) a 1000 mA continuous test to 1.0 V at −20° C.). The average capacities, indexed to Lot 23 (made like Lot 21 in Example 2), are summarized in Table 3. In general, the higher the LiI concentration, the higher the high rate discharge capacity at room temperature, but with 1.5 moles of LiI per liter of solvent, sudden voltage drops resulted in little capacity on 1000 mA continuous discharge at −20° C.

TABLE 3

| | | | | 1000 mA | |
|---|---|---|---|---|---|
| | | | DSC to | cont. to | 1000 mA |
| | DIOX/ | LiI | 1.05 V | 1.0 V | cont. to |
| Lot | DME | (mol/l | (room | (room | 1.0 V |
| No. | (vol.) | solvent) | temp.) | temp.) | (−20° C.) |
| 22 | 65/35 | 0.5 | 92 | 90 | 99 |
| 23 | 65/35 | 0.75 | 100 | 100 | 100 |
| 24 | 65/35 | 1 | 104 | 103 | 84 |
| 25 | 65/35 | 1.25 | 104 | 108 | 109 |
| 26 | 65/35 | 1.5 | 107 | 107 | 1 |

### EXAMPLE 4

FR6 cells similar to those in Example 2 were made using various electrolytes. All electrolytes had solvents consisting of DIOX and DME, in varying ratios, as well as 0.2 volume percent DMI; the ratio of the combination of DIOX and DME to DMI was 99.8:0.2 by volume. All electrolytes had solutes consisting of LiI, LiTFS or a mixture thereof. The DIOX:DME ratio, total solute concentration and LiI concentration for each lot are included in Table 4.

Cells from each lot were tested on a composite discharge test at room temperature. On this test, each cell was first discharged continuously to 1.0 V on a series of constant current segments (2000 mA, 1500 mA, 1000 mA, 750 mA, 500 mA, 400 mA, 300 mA, 200 mA, 100 mA and 20 mA), with 2 hours rest between successive discharge segments. The cumulative capacities after the 2000, 1000, 200 and 20 mA segments of the test, indexed to Lot 42, are summarized in Table 4. Overall, the best performance was with Lot 42, those lots with higher LiI/LiCF₃SO₃ ratios and/or higher LiI concentrations performed better on the high rate discharge segments of the test, and those lots with only LiCF₃SO₃ as a solute performed very poorly on high rate discharge.

TABLE 4

| | | | Total | | | | | |
|---|---|---|---|---|---|---|---|---|
| | DIOX/ | LiI/ | Salt | LiI | | | | |
| Lot | DME | LiTFS | (mol/l | (mol/l | 2000 | 1000 | 200 | 20 |
| No. | (vol.) | (mol.) | solvent) | solvent) | mA | mA | mA | mA |
| 27 | 60/40 | 70/30 | 0.75 | 0.525 | 90 | 98 | 98 | 98 |
| 28 | 60/40 | 35/65 | 0.65 | 0.228 | 62 | 73 | 96 | 98 |
| 29 | 70/30 | 35/65 | 0.75 | 0.263 | 67 | 78 | 97 | 98 |
| 30 | 50/50 | 70/30 | 0.65 | 0.455 | 84 | 95 | 97 | 98 |
| 31 | 50/50 | 35/65 | 0.75 | 0.263 | 81 | 93 | 96 | 96 |
| 32 | 70/30 | 35/65 | 0.55 | 0.193 | 11 | 54 | 95 | 98 |
| 33 | 50/50 | 0/100 | 0.65 | 0.000 | 1 | 51 | 96 | 100 |
| 34 | 60/40 | 35/65 | 0.65 | 0.228 | 67 | 82 | 95 | 96 |
| 35 | 50/50 | 35/65 | 0.55 | 0.193 | 52 | 70 | 95 | 97 |
| 36 | 60/40 | 0/100 | 0.55 | 0.000 | <1 | 26 | 92 | 99 |
| 37 | 60/40 | 70/30 | 0.55 | 0.385 | 66 | 83 | 95 | 96 |
| 38 | 70/30 | 0/100 | 0.65 | 0.000 | <1 | 38 | 93 | 98 |
| 39 | 70/30 | 70/30 | 0.65 | 0.455 | 80 | 92 | 96 | 97 |
| 40 | 60/40 | 35/65 | 0.65 | 0.228 | 47 | 78 | 96 | 97 |
| 41 | 60/40 | 0/100 | 0.75 | 0.000 | 1 | 54 | 97 | 101 |
| 42 | 65/35 | 100/0 | 0.75 | 0.750 | 100 | 100 | 100 | 100 |

Cells from each lot were also tested on each of three tests: (1) the DSC test described in Example 3, (2) a 1000 mA continuous test to 1.0 V at −20° C., and (3) the 1250 mA continuous test described in Example 2. The results, summarized in Table 5, are indexed to Lot 42 (made like Lots 21 and 23 above), except for the 1250 mA continuous test, on which the cells from Lot 42 gave essentially no capacity due to their rapid voltage drop to less than 0.773 V; for this test the results are shown in minutes. In general, the relationship among lots on the DSC test was similar to the relationships among lots on the high rate portions of the composite test summarized in Table 4. However, on the 1250 mA continuous test at −30° C., the lots that performed best at room temperature (Lots 42 and 27) exhibited sudden voltage drops, resulting in essentially no capacity.

TABLE 5

| | | | Total | | | | 1250 mA |
|---|---|---|---|---|---|---|---|
| | | | Salt | LiI | DSC to | 1000 mA | cont. to |
| | DIOX/ | LiI/ | (mol/ | (mol/ | 1.05 V | cont. to | 0.773 V |
| | DME | LiTFS | l sol- | l sol- | (room | 1.0 V | (−30° C.) |
| No. | (vol.) | (mol.) | vent) | vent) | temp.) | (−20° C.) | (minutes) |
| 27 | 60/40 | 70/30 | 0.75 | 0.525 | 94 | 99 | 0 |
| 28 | 60/40 | 35/65 | 0.65 | 0.228 | 75 | 71 | 38 |
| 29 | 70/30 | 35/65 | 0.75 | 0.263 | 72 | 65 | 44 |
| 30 | 50/50 | 70/30 | 0.65 | 0.455 | 93 | 120 | 28 |
| 31 | 50/50 | 35/65 | 0.75 | 0.263 | 84 | 119 | 60 |
| 32 | 70/30 | 35/65 | 0.55 | 0.193 | 44 | 16 | 15 |
| 33 | 50/50 | 0/100 | 0.65 | 0.000 | 2 | 19 | 37 |
| 34 | 60/40 | 35/65 | 0.65 | 0.228 | 73 | 75 | 74 |
| 35 | 50/50 | 35/65 | 0.55 | 0.193 | 63 | 68 | 42 |
| 36 | 60/40 | 0/100 | 0.55 | 0.000 | <1 | 1 | 2 |
| 37 | 60/40 | 70/30 | 0.55 | 0.385 | 85 | 79 | 42 |
| 38 | 70/30 | 0/100 | 0.65 | 0.000 | <1 | 1 | 2 |
| 39 | 70/30 | 70/30 | 0.65 | 0.455 | 87 | 116 | 19 |
| 40 | 60/40 | 35/65 | 0.65 | 0.228 | 76 | 74 | 41 |
| 41 | 60/40 | 0/100 | 0.75 | 0.000 | 31 | 59 | 56 |
| 42 | 65/35 | 100/0 | 0.75 | 0.750 | 100 | 100 | 0 |

### EXAMPLE 5

Statistical analyses of discharge test data for cells from Examples 2 and 4 were done using DESIGN EXPERT® software from Stat-Ease Inc., Minneapolis, Minn., USA, to predict the best electrolyte formulation parameters for optimizing capacity on the DSC test at room temperature (to 1.1 V for Example 2, 1.05 V for Example 4), 2000 mA continuous discharge at room temperature, 1000 mA continuous discharge at −20° C. and 1250 mA continuous discharge at −30° C. The results (best electrolyte parameters and predicted capacities) are summarized in Table 6; predicted capacities are indexed to cells with an electrolyte having a solvent consisting of DIOX, DME and DMI in a volume ratio of 65:35:0.2 and a solute consisting of 0.75 moles of LiI per liter of solvent. The asterisks (*) indicate no predicted rapid voltage drop below 0.773 V on 1250 mA discharge at −30° C.

TABLE 6

| Electrolyte | Relative Capacity | | | | | | | | |
|---|---|---|---|---|---|---|---|---|---|
| Parameter or | Best DSC | | Best 2000 mA | | Best 1000 mA | | Best 1250 mA | | |
| Discharge | at room temp. | | at room temp. | | at −20°C. | | at −30° C. | | |
| Test | Ex. 2 | Ex. 4 | Ex. 2 | Ex. 4 | Ex. 2 | Ex. 4 | Ex. 2 | Ex. 4 | Ex. 4 |
| DIOX/ | 53.6/ | 57.4/ | 52.6/ | 61.3/ | 64.7/ | 52.5/ | 64.9/ | 50.2/ | 51.6/ |
| DME (vol.) | 46.4 | 42.6 | 47.4 | 38.7 | 35.3 | 47.5 | 35.1 | 49.8 | 48.4 |
| Total solute | 0.937 | 0.726 | 0.992 | 0.748 | 0.807 | 0.727 | 0.751 | 0.554 | 0.750 |
| (moles/l) | | | | | | | | | |
| LiI/LiTFS | 100/ | 64.3/ | 97.1/ | 69.7/ | 78.8/ | 67.0/ | 70.4/ | 68.3/ | 0.2/ |
| (moles | 0 | 35.7 | 2.9 | 30.3 | 21.2 | 33.0 | 29.6 | 31.7 | 99.8 |
| LiI | 0.937 | 0.466 | 0.964 | 0.522 | 0.635 | 0.487 | 0.529 | 0.378 | 0.001 |
| (moles/l) | | | | | | | | | |
| LiTFS | 0.000 | 0.259 | 0.029 | 0.226 | 0.171 | 0.240 | 0.222 | 0.176 | 0.748 |
| (moles/l) | | | | | | | | | |
| 2000 mA | | | | | | | | | |
| to 1.0 V, | 116 | 69 | 119 | 75 | 104 | 71 | 99 | 56 | 18 |
| room temp. | | | | | | | | | |
| DSC test, | 111 | 109 | 111 | 111 | 100 | 108 | 94 | 85 | 25 |
| room temp. | | | | | | | | | |
| 1000 mA | | | | | | | | | |
| to 1.0 V, | 77 | 109 | 70 | 111 | 117 | 121 | 146 | 95 | 63 |
| −20° C. | | | | | | | | | |
| 1250 mA | | | | | | | | | |
| to 1.0 V, | 13 | * | 9 | * | 38 | * | 46 | * | * |
| −30° C. | | | | | | | | | |

The surface response chart generated by the statistical analysis software was used to select suitable ranges for electrolyte composition parameters disclosed above expected to provide usable capacity on 1250 mA discharge at −30° C., good capacity on 1000 mA discharge at −20° C. and minimal loss in high rate capacity, compared to cells with an electrolyte containing 0.75 moles of LiI per liter of solvent consisting of DIOX, DME and DMI in a volume ratio of 65:35:0.2.

It will be understood by those who practice the invention and those skilled in the art that various modifications and improvements may be made to the invention without departing from the spirit of the disclosed concept. The scope of protection afforded is to be determined by the claims and by the breadth of interpretation allowed by law.

The invention claimed is:

1. An electrochemical battery cell comprising an alkali metal negative electrode, an iron sulfide positive electrode, a separator disposed between the negative and positive electrodes, and a liquid electrolyte, wherein the electrolyte comprises:
a solvent comprising at least 80 volume percent ethers, and the ethers comprising a 1,3-dioxolane based ether and a 1,2-dimethoxyethane based ether in a volume ratio greater than 45:55 and less than 85:15; and
a solute comprising lithium iodide and one or more additional salts dissolved in the solvent; wherein:
the electrolyte contains a total solute concentration of from 0.40 to 2.00 moles per liter of solvent;
when the electrolyte comprises from 0.40 to 0.65 moles of solute per liter of solvent, the solute contains at least 35 mole percent lithium iodide; and
when the electrolyte comprises from greater than 0.65 to 2.00 moles of solute per liter of solvent, the solute contains less than 35 mole percent lithium iodide.

2. The cell as defined in claim 1, wherein the one or more additional salts are lithium salts.

3. The cell as defined in claim 1, wherein the one or more additional salts comprise lithium trifluoromethane sulfonate.

4. The cell defined in claim 1, wherein the volume ratio of the 1,3-dioxolane based ether to the 1,2-dimethoxyethane based ether is no greater than 75:25.

5. The cell defined in claim 4, wherein the volume ratio of the 1,3-dioxolane based ether to the 1,2-dimethoxyethane ether is no greater than 70:30.

6. The cell defined in claim 5, wherein the volume ratio of the 1,3-dioxolane based ether to the 1,2-dimethoxyethane based ether is no greater than 65:35.

7. The cell defined in claim 1, wherein the volume ratio of the 1,3-dioxolane based ether to the 1,2-dimethoxyethane based ether is at least 50:50.

8. The cell defined in claim 1, wherein the solvent comprises a total of at least 80 volume percent of the 1,2-dimethoxyethane based ether and the 1,3-dioxolane based ether.

9. The cell defined in claim 8, wherein the solvent comprises a total of at least 90 volume percent of the 1,2-dimethoxyethane based ether and the 1,3-dioxolane based ether.

10. The cell defined in claim 1, wherein the 1,3-dioxolane based ether is 1,3-dioxolane.

11. The cell defined in claim 1, wherein the 1,2-dimethoxyethane based ether is 1,2-dimethoxyethane.

12. The cell defined in claim 1, wherein the solvent further comprises at least one additional solvent.

13. The cell defined in claim 12, wherein the additional solvent is at least one member selected from the group consisting of 3,5-dimethylisoxazole, 1,2-dimethoxypropane, 3-methyl-2-oxazolidinone, and beta aminoenones.

14. The cell defined in claim 13, wherein the additional solvent comprises 3,5-dimethylisoxazole.

15. The cell defined in claim 1, wherein the electrolyte contains from 0.40 to 0.65 moles of total solute per liter of solvent.

16. The cell defined in claim 15, wherein the electrolyte contains at least 0.50 moles of total solute per liter of solvent.

17. The cell defined in claim 15, wherein a mole ratio of lithium iodide to the one or more additional salts is from 60:40 to 90:10.

18. The cell defined in claim 16, wherein a mole ratio of lithium iodide to the one or more additional salts is from 65:35 to 75:25.

19. The cell defined in claim 1, wherein the electrolyte contains from greater than 0.65 to 2.0 moles of total solute per liter of solvent.

20. The cell defined in claim 19, wherein the electrolyte contains no more than 1.50 moles of total solute per liter of solvent.

21. The cell defined in claim 20, wherein the electrolyte contains no more than 1.20 moles of total solute per liter of solvent.

22. The cell defined in claim 19, wherein a mole ratio of lithium iodide to the one or more additional salts is from 10:90 to 30:70.

23. The cell defined in claim 22, wherein a mole ratio of lithium iodide to the one or more additional salts is from 10:90 to 20:80.

24. The cell defined in claim 19, wherein the electrolyte contains no more than 0.20 moles of lithium iodide per liter of solvent.

25. The cell defined in claim 19, wherein the electrolyte contains at least 0.10 moles of lithium iodide per liter of solvent.

26. The cell defined in claim 1, wherein the iron sulfide positive electrode comprises at least one of FeS and FeS₂.

27. The cell defined in claim 1, wherein the alkali metal comprises metallic lithium.

28. The cell defined in claim 1, wherein the metallic lithium is alloyed with aluminum.

29. A primary electrochemical battery cell comprising negative electrode comprising metallic lithium, a positive electrode comprising FeS₂, a separator disposed between the negative and positive electrodes, and a liquid electrolyte, wherein the electrolyte comprises:
a solvent comprising at least 80 volume percent ethers, and the ethers comprising 1,3-dioxolane and 1,2-dimethoxyethane in a volume ratio greater than 45:55 and less than 85:15; and
a solute comprising lithium iodide and lithium trifluoromethane sulfonate; wherein
the electrolyte contains a total solute concentration of from 0.40 to 0.65 moles per liter of solvent and the solute contains at least 35 mole percent lithium iodide.

30. The cell defined in claim 29, wherein the total solute concentration is from 0.50 to 0.60 moles per liter of solvent.

31. A primary electrochemical battery cell comprising a negative electrode comprising metallic lithium, a positive electrode comprising FeS₂, a separator disposed between the negative and positive electrodes, and a liquid electrolyte, wherein the electrolyte comprises:
a solvent comprising at least 80 volume percent ethers, and the ethers comprising 1,3-dioxolane and 1,2-dimethoxyethane in a volume ratio greater than 45:55 and less than 85:15; and
a solute comprising lithium iodide and lithium trifluoromethane sulfonate; wherein
the electrolyte contains a total solute concentration of from greater than 0.65 to 2.00 moles per liter of solvent and the solute contains less than 35 mole percent lithium iodide.

32. The cell defined in claim 31, wherein the total solute concentration is from 0.70 to 1.20 moles per liter of solvent.
